(19) United States
(12) Patent Application Publication
(10) Pub. No.: US 2013/0145991 A1
(43) Pub. Date: Jun. 13, 2013

(54) Hog Guard

(71) Applicant: Roy Jackson, Tuscola, TX (US)

(72) Inventor: Roy Jackson, Tuscola, TX (US)

(21) Appl. No.: 13/495,782

(22) Filed: Jun. 13, 2012

Related U.S. Application Data
(60) Provisional application No. 61/520,720, filed on Jun. 15, 2011.

(51) Int. Cl. A01K 1/02

(52) U.S. Cl. CPC A01K 1/0209
USPC 119/502

(57) ABSTRACT

An animal barrier system for deterring hogs and or other small animals from entering a protected area they include a barrier section including an outer frame member, and opposed interior frame member being opposed to the outer frame member, and a side frame member to connect the outer frame member and the inner frame member. The barrier section may include a first section of a first angled wall.

### PRIORITY

The present invention claims priority based upon 35 USC section 119 and based upon a provisional application with a Ser. No. of 61/520,720 which was filed on Jun. 15, 2011.

### FIELD OF THE INVENTION

The present invention relates to an animal barrier and more particularly to a animal barrier to keep hogs out from protected areas.

### BACKGROUND

It is well-known that people generally enjoy watching deer and other animals especially the people who live in the rural areas where these types of animals exist. In order to facilitate the watching of deer and other animals, people may provide food and other attractions in order to encourage the deer and other animals to congregate.

However, there exist other animals which are undesirable such as hogs which may be attracted to the food. These animals not only will deprive the deer from the food, but may cause significant damage near and around the feeder which may contain the food for the deer and other animals. It is desirable to deter the hogs and other animals from reaching the feeder and food for the deer's and other desirable animals.

### SUMMARY

An animal barrier system for deterring hogs and or other small animals from entering a protected area they include a barrier section including an outer frame member, and opposed interior frame member being opposed to the outer frame member, and a side frame member to connect the outer frame member and the inner frame member. The barrier section may include a first section of a first angled wall.

The first angled wall may be at an acute angle.

The first angled wall may be at an angle of 45° with respect to the vertical.

The barrier section may include a second section of a second angled wall at a different angle than the first angled wall.

The second angled wall may be at an angle of 45° with respect to the vertical

### BRIEF DESCRIPTION OF THE DRAWINGS

The invention may be understood by reference to the following description taken in conjunction with the accompanying drawings, in which, like reference numerals identify like elements, and in which:

FIG. 1 illustrates a perspective view of the animal barrier system of the present invention;

FIG. 2 illustrates a top perspective view of a animal barrier section of the animal barrier system of the present invention;

FIG. 3 illustrates a bottom perspective view of the animal barrier section of the animal barrier system of the present invention;

FIG. 4 illustrates a cross-sectional view of the animal barrier section of the animal barrier system of the present invention;

FIG. 5 illustrates a perspective view of a multitude of substantially mirror animal barrier sections of the animal barrier system of the present invention;

FIG. 6 illustrates another animal barrier section of the animal barrier system of the present invention;

FIG. 7 illustrates a top perspective view of the animal barrier section of the animal barrier system of the present invention;

FIG. 8 illustrates a perspective view of multiple substantially mirror animal barrier sections of the present invention

FIG. 9 illustrates the first angled frame member and the substantially mirrored second angled frame member of the animal barrier section of the present invention.

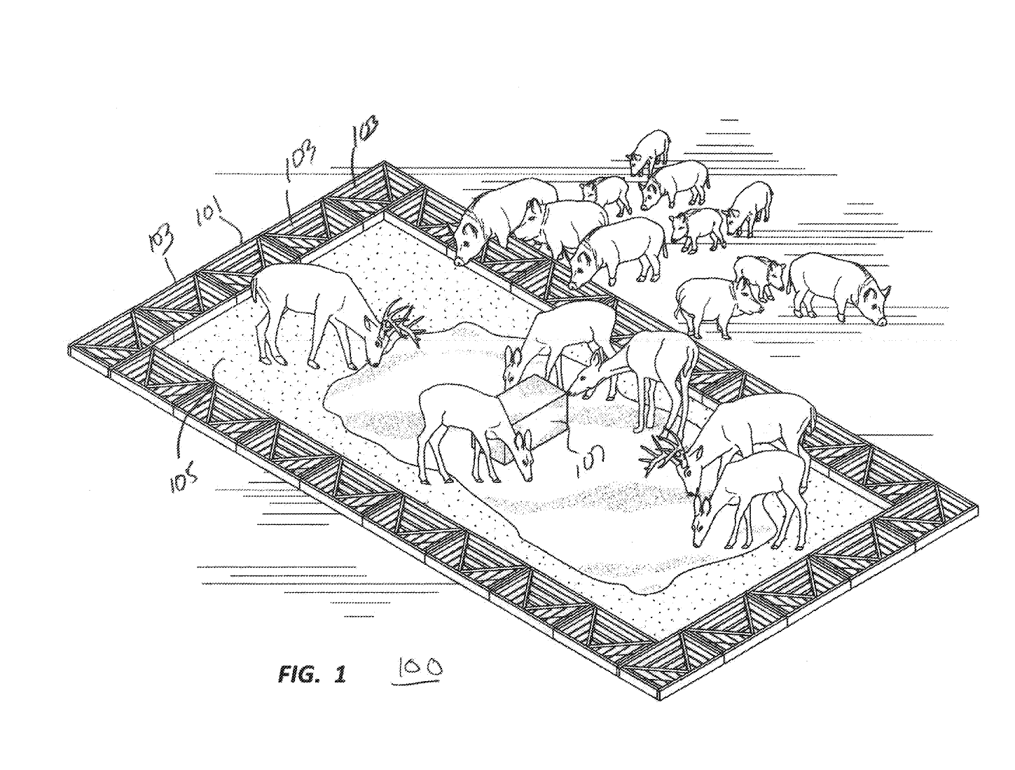

### DETAILED DESCRIPTION

The present invention provides an animal barrier system 100 which may provide a barrier 101 to inhibit animals from crossing the barrier which may lack the ability to jump the barrier and which have a relatively short leg length. The animal barrier system 100 may include the barrier 101 which may have a low profile and have a width which may allow certain animals such as deer to jump the barrier 101. The animal barrier system 100 is adapted to be positioned on the ground and connected together end to end to encircle game feeders, gardens or other devices needing protection from feral hogs and the like. The animal barrier system 100 may include angled slats positioned in different directions to prevent the hooves of the hogs to navigate through the animal barrier system 100. The animal barrier system 100 maybe formed to enclose any sized area. The width of the animal barrier system 100 may be sufficiently narrow to allow deer to step over the animal barrier system 100 with little or no problems. The slats may be angled at 45° in different directions and may be positioned a predetermined distance from the ground causing the legs of the hogs to twist with these steps, preventing the hogs from entering the protected area. The low-profile and frame of the animal barrier system may allow a vehicle to drive over the animal frame system 100. The material of the animal frame system 100 may be weatherproof to withstand outdoor elements year-round. The frame system 100 may be used in cooperation with a barb wire fence and may be attached between posts to prevent the migration of groups of hogs from one field to another and to alleviate the spread of disease and damage caused by feral hogs.

The barrier 101 may include multiple substantially mirror animal barrier sections 103 which may be arranged in a multitude of ways in order to define a protected area 105 which may include a food dispenser 107 in order to attract animals such as deer which may have the capability of jumping the animal barrier section 103 in order to enter the protected area 105. The protected area 105 may be any suitable shape and may include a substantially rectangular shape, an substantially oval-shape, a substantially circular shape or other shape.

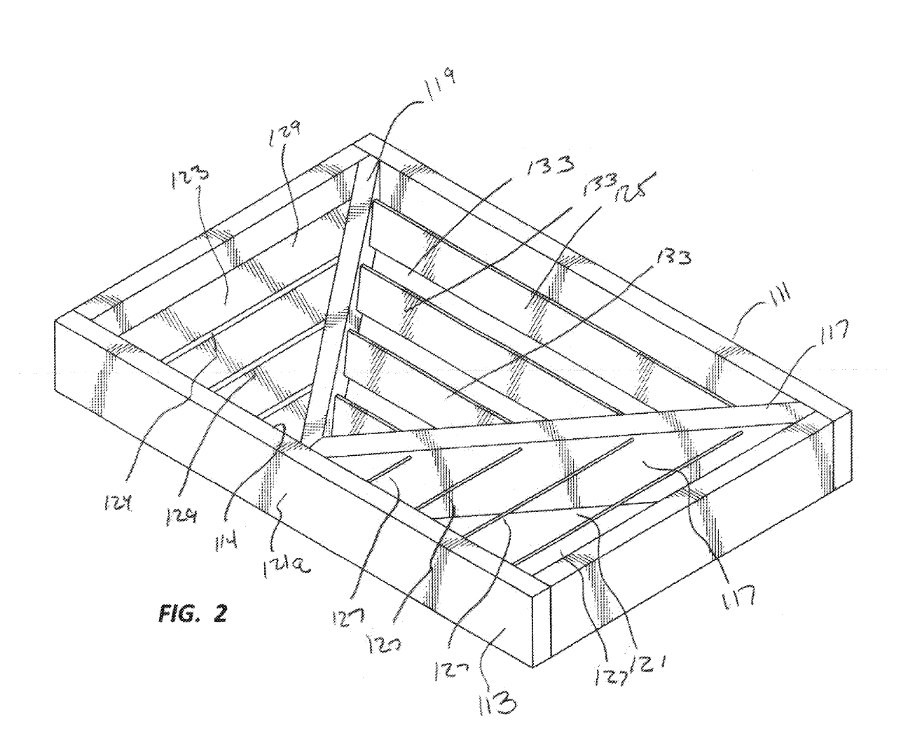

FIG. 2 illustrates a top perspective view of the animal barrier section 103 which may be solid or hollow, which may be formed from metal, plastic, wood or other material and which may include an outer frame member 111 which may have planar surfaces and may have a substantially rectangular cross-section, an interior frame member 113 which may have planar surfaces, may have a substantially rectangular cross-section and may be opposed to the outer frame member 111, a pair of opposing side frame members 115 which may have planar surfaces, may have a substantially rectangular cross-section and may connect the outer frame member 111 with the interior frame member 113. Additionally, the animal barrier section 103 may include a first angled frame member 117 which may have planar surfaces and may have a substantially rectangular cross-section and may connect to the intersection of the outer frame member 111 and the side frame member 115 to form an acute angle with the outer frame member 111 and the side frame member 115 and may connect to substantially the midpoint 121a of the interior frame member 113, and the animal barrier section 103 may include a second angled frame member 119 which may have planar surfaces and may have a substantially rectangular cross-section and may connect to the interconnection of the opposing end of the outer frame member 111 and the opposing side frame member 115 and may connect to the substantial midpoint 121a of the interior frame member 113 to form an acute angle with the outer frame member, interior frame member 113 and the side frame member 115. The surfaces of the outer frame member 111, the interior frame member 113, the side frame member 115, the first angled frame member 117 and a second angled frame member 119 may be substantially either horizontal or vertical.

The first angled frame member 117 or the substantially mirror second angled frame member 119 as shown in FIG. 9 may include a front surface 211 which may be opposed to a back surface 213 and may be connected to a pair of opposing side surfaces 209, a top surface 205 and a bottom surface 207, the top surface 205 may be connected to the pair of opposing side surfaces 209, the front surface 211, and the back surface 213, the bottom surface 207 may be connected to the pair of opposing side surfaces 209, the front surface 211 and the back surface 213, the back surface 213 may be connected to the top surface 205, the bottom surface 207, and the pair of side surfaces 209 may be connected to the top surface 205, the bottom surface 207, front surface 211 and the back surface 203.

Returning to FIG. 2, the animal barrier section 103 may include a first section 121 of first angled walls 127 which may extend between the interior frame member 113 to the first angled frame member 117, a second section 123 of second angled walls 129 which may extend from the interior frame member 113 to the second angled frame member 119 and a third section 125 of third angled walls 133 which may extend substantially perpendicular to the first angled walls 127 and the second angled walls 129. Additional or fewer sections are within the scope of the present invention.

The first angled walls 127, the second angled walls 129 and the third angled walls 131 may be slanted or angled at an acute angle (‘a’ which may be 45°) with respect to the side surface 209 of the first angled frame member 117 and the second angled frame member 119 (mirror to member 117) and to the interior surface 114 of the interior frame member 113 and to the substantial vertical. The first angled walls 127, the second angled walls 129 and the third angled walls 131 may provide a hindrance to the foot and leg of an undesirable animal by causing it to be caught or restrained between adjacent angled walls 127, 129, 131.

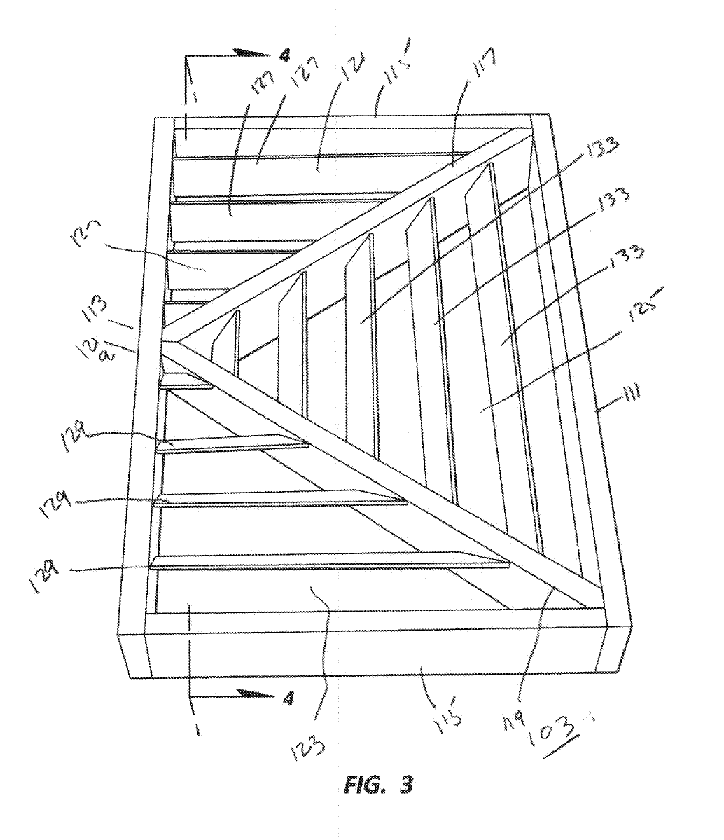

FIG. 3 illustrates a bottom perspective view of the animal barrier section 103 which may be solid or hollow, which may be formed from metal, plastic, wood or other material and which may include an outer frame member 111 which may have planar surfaces and may have a substantially rectangular cross-section, an interior frame member 113 which may have planar surfaces, may have a substantially rectangular cross-section and may be opposed to the outer frame member 111, a pair of opposing side frame members 115 which may have planar surfaces, may have a substantially rectangular cross-section and may connect the outer frame member 111 with the interior frame member 113. Additionally, the animal barrier section 103 may include a first angled frame member 117 which may have planar surfaces and may have a substantially rectangular cross-section and may connect to the intersection of the outer frame member 111 and the side frame member 115 to form an acute angle with the outer frame member 111 and the side frame member 115 and may connect to substantially the midpoint 121a of the interior frame member 113, and the animal barrier section 103 may include a second angled frame member 119 which may have planar surfaces and may have a substantially rectangular cross-section and may connect to the interconnection of the opposing end of the outer frame member 111 and the opposing side frame member 115 and may connect to the substantial midpoint 121a of the interior frame member 113 to form an acute angle with the outer frame member, interior frame member 113 and the side frame member 115. The surfaces of the outer frame member 111, the interior frame member 113, the side frame member 115, the first angled frame member 117 and a second angled frame member 119 may be substantially either horizontal or vertical.

The animal barrier section 103 may include a first section 121 of first angled walls 127 which may extend between the interior frame member 113 to the first angled frame member 117, a second section 123 of second angled walls 129 which may extend from the interior frame member 113 to the second angled frame member 119 and a third section 125 of third angled walls 133 which may extend substantially perpendicular to the first angled walls 127 and the second angled walls 129. Additional or fewer sections are within the scope of the present invention.

The first angled walls 127, the second angled walls 129 and the third angled walls 131 may be slanted or angled at an acute angle with respect to the side surface 209 of the first angled frame member 117 and the second angled frame member 119 (mirror to member 117) and may be angled with respect to the substantial vertical and to the interior surface 114 of the interior frame member 113. The first angled walls 127, the second angled walls 129 and the third angled walls 131 may provide a hindrance to the foot and leg of an undesirable animal by causing it to be caught or restrained between adjacent angled walls 127, 129, 131.

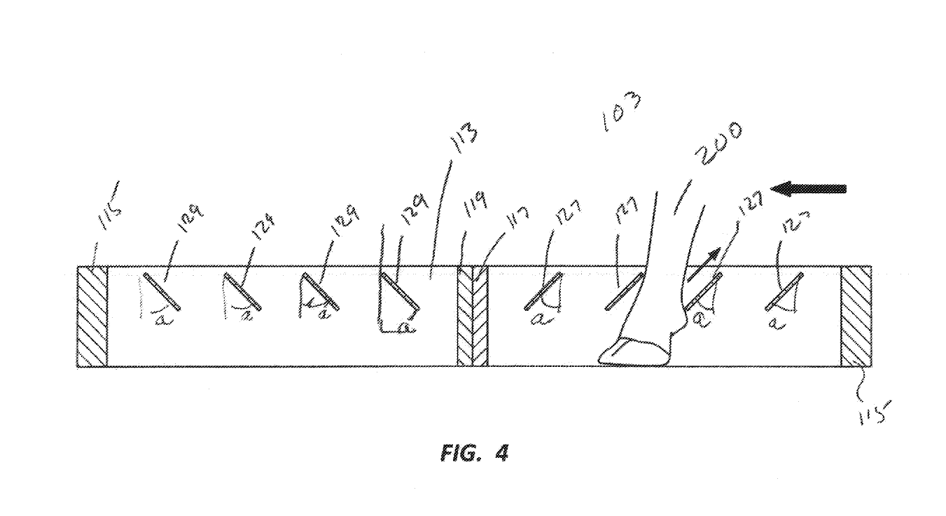

FIG. 4 illustrates a cross-sectional view of the animal barrier section 103 and illustrates the interior frame member 113, the side frame member 115, the first angled frame member 117, the second angled frame member 119, the first angled walls 127, the second angled walls 129 and the animal foot 200.

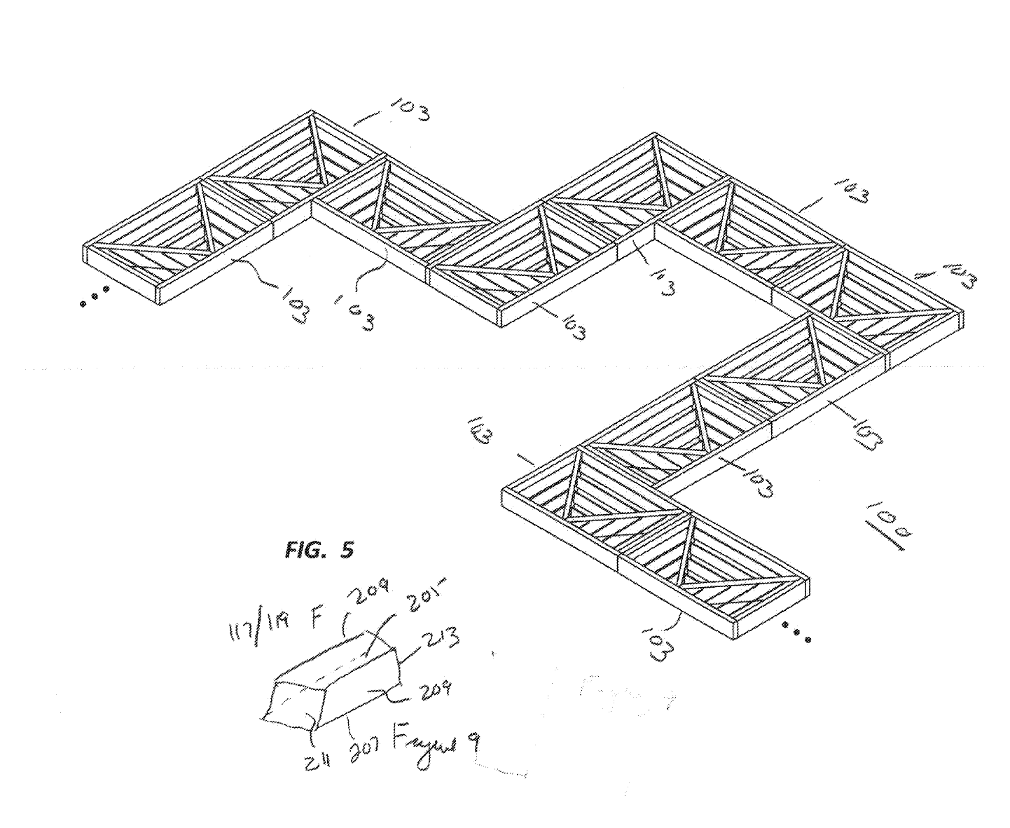

FIG. 5 illustrates an another configuration of the animal barrier sections 103.

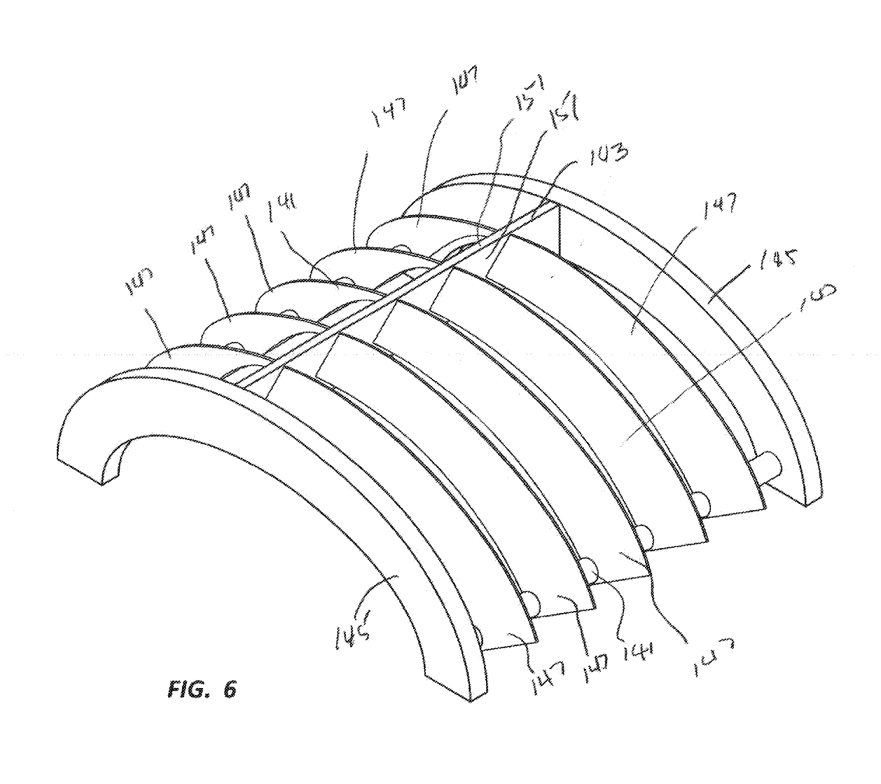

FIG. 6 illustrates another embodiment for the animal barrier sections 603. The animal barrier section 603 may be convexly curved and may be shaped as a truncated cylinder or other appropriate shape. The animal barrier section 603 may include a central support frame member 143 and a pair of opposed end frame members 145. The central support frame member 143 may be substantially rectangular and planar, and the end frame member 105 may include a substantially rectangular cross-section, convexly curved with planar surfaces. A pair of opposed connecting rods 141 may extend between the pair of opposing end frame members 105 and through the curved deflection walls 147 to support the curved deflection walls 147 which may be angled at an acute angle with respect to the substantial vertical and with respect to the side surface 151 of the central support frame member 143.

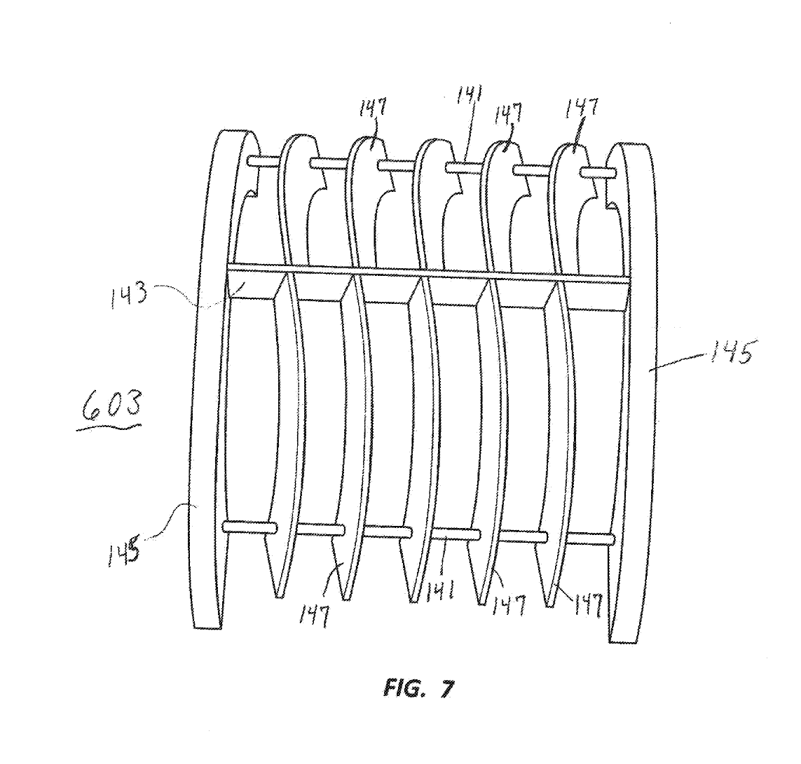

FIG. 7 illustrates a top perspective view of the animal barrier sections 603. The animal barrier section 603 may be convexly curved and may be shaped as a truncated cylinder or other appropriate shape. The animal barrier section 603 may include a central support frame member 143 and a pair of opposed end frame members 145. The central support frame member 143 may be substantially rectangular and planar, and the end frame member 105 may include a substantially rectangular cross-section, convexly curved with planar surfaces. A pair of opposed connecting rods 141 may extend between the pair of opposing end frame members 105 and through the curved deflection walls 147 to support the curved deflection walls 147 which may be angled at an acute angle with respect to the substantial vertical and with respect to the side surface 151 of the central support frame member 143.

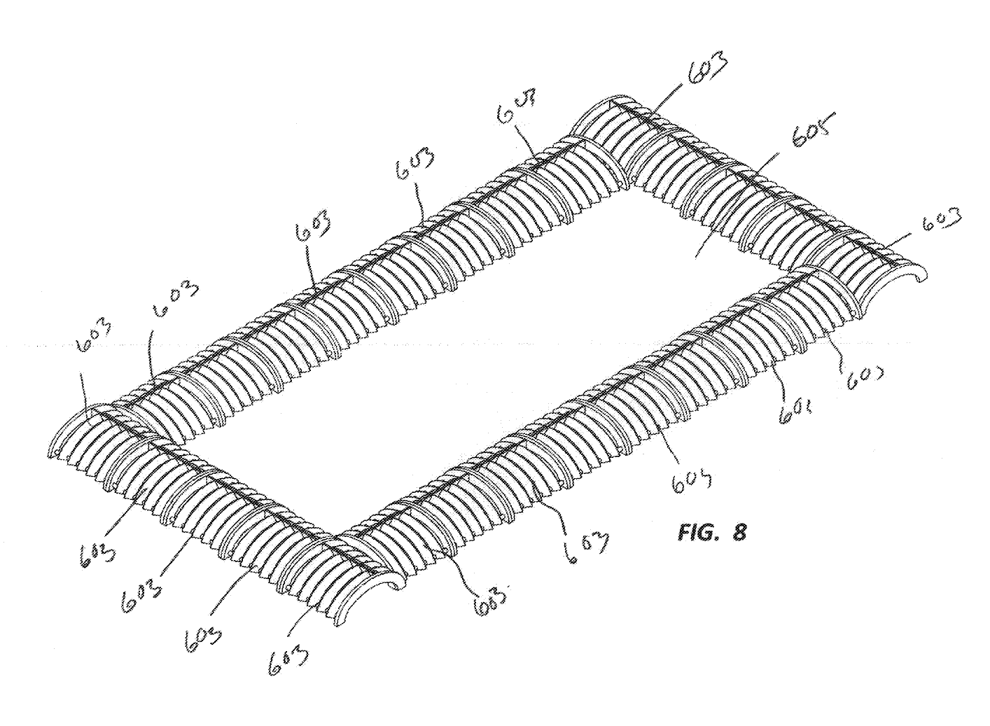

FIG. 8 illustrates a multitude of animal barrier sections 603 positioned to form a protected area 605

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed.

1) An animal barrier system for deterring hogs and or other small animals from entering a protected area, comprising:
a barrier section including an outer frame member, and opposed interior frame member being opposed to the outer frame member, and a side frame member to connect the outer frame member and the inner frame member;
wherein the barrier section includes a first section of a first angled wall.

2) An animal barrier system for deterring hogs and or other small animals from entering a protected area as in claim 1, wherein the first angled wall is at an acute angle.

3) An animal barrier system for deterring hogs and or other small animals from entering a protected area as in claim 1, wherein the first angled wall is at an angle of 45° with respect to the vertical.

4) An animal barrier system for deterring hogs and or other small animals from entering a protected area as in claim 1, wherein the barrier section includes a second section of a second angled wall at a different angle than the first angled wall.

5) An animal barrier system for deterring hogs and or other small animals from entering a protected area as in claim 1, wherein the second angled wall is at an angle of 45° with respect to the vertical
